(19) United States
(12) Patent Application Publication
(10) Pub. No.: US 2012/0078519 A1
(43) Pub. Date: Mar. 29, 2012

(54) DIFFERENTIAL LEVEL MONITORING DEVICE

(75) Inventors: Franco Robotti, Segrate (IT); Umberto Mainardi, Villa Di Sero (IT)

(73) Assignee: AGISCO S.r.l., Milano (IT)

(21) Appl. No.: 13/322,081

(22) PCT Filed: May 24, 2010
(86) PCT No.: PCT/EP2010/057085

§ 371 Date: Nov. 22, 2011

(30) Foreign Application Priority Data
May 25, 2009 (EP) 09425205.3

(51) Int. Cl. G06F 19/00

(52) U.S. Cl. 702/5

(57) ABSTRACT

A device (10), specifically tailored to measure the development of soil and, preferably, of seabed surface (14) profile is characterized by a waterproof/airtight casing housing:
an hydraulic pressurized circuit (15), extending along a longitudinal direction, filled with a specific liquid;
a pneumatic circuit (16), extending along the same longitudinal direction, and connected to the above hydraulic circuit (15) at one or more points; this pneumatic circuit (16) is filled with air kept at a constant pressure, or with inert gas allowing pressurization of the above said hydraulic circuit (15);
a number of differential pressure transducers (18, 20, 22), placed at the above said one or more connections between the hydraulic circuit (15) and the pneumatic circuit (16);
an electronic control circuit including: means for data acquisition, (said data come from the above said pressure transducers (18, 20, 22) and are related to pressure measurements at each of said one or more points); means for calculation of pressure difference in respect to a reference point, the so called benchmark (13); means for storage of recorded data; and means for data transmission to a remote control unit (28),
   so that it is possible to compute the difference of altitude profile at one or more said points in respect to said benchmark (13); such an altitude profile difference, being for the communicating vessels principle directly proportional to the corresponding detected pressure difference, allows determination of the altitude profile of device (10) all along its longitudinal length.

This invention concerns a device specifically tailored to detect and measure the land profile or, more specifically the seabed profile from few meters up to many kilometres.

More specifically, the instrument is able to detect some vertical differential or specific settlements of soil and seabed profile, and monitor its development in the course of time, as a function, for example, of currents, earthquakes and/or subsidence events. This instrument's specific structure allows operation even in very harsh environments with extremely high outer pressure (up to about 10 MPa) on earth or undersea environment.
The instrument works on the principle of the communicating vessels, and basically uses two circuits: the former made of an hydraulic pipe, the latter made of a pneumatic pipe. The altitude profile variations at different points along the hydraulic piping cause matching variations of the inner pressures due to the fact that the contained liquid free surface, in hydrostatic equilibrium, tends to follow an equipotential surface of the earth gravity field. The pneumatic circuit, filled with air or gas at a constant pressure, is communicating with the former hydraulic circuit at different points. Some proper means are installed, in correspondence to the position of these points, to detect the pressure difference in respect of a reference point, called benchmark, and consequently the altitude profile difference that is directly proportional.
By so doing it is possible to define the geometrical profile of altitude variations all along the longitudinal length of the same device. The bigger the number of measuring points the more detailed will result the reconstructed profile.

The state-of-the-art reports an attempt to solve this technical problem by means of a special equipment laid on the seabed that measures, using a pressure transducer, the weight of the upper water column. A variation in time of the detected pressure involves a level variation of the equipment vertical position and, consequently, a possible subsiding movement of the seabed. It is clear that this solution involves some significant and difficult drawbacks due to the extent of displacements to be measured in comparison to a reference absolute value.

Let's imagine, as an example, an equipment placed on the seabed at 100 m depth, to detect displacements of centimetres in magnitude. Additional measurement problems are likely to arise from the dynamical components of natural events, such as surface waves, tidal currents, etc. In addition, the device working principle requires, when installed, to protrude from the seabed, thus exposing the instrument to a risk of damage, unless expensive structures are provided as special shielding. Furthermore, standard operations and maintenance activities would require a frequent access by skilled diving technicians, both for collection of recorded data, and replacement of power batteries.

This invention will overcome and solve all above problems, its main goal consisting in the development of a measuring device tailored to measure the development of soil or seabed geometrical profile. The device would be totally sealed off and house a pressurised hydraulic circuit where differential pressure transducers are placed.

Another goal consists in the supply of data related to measured pressures with reference to respective points of the same hydraulic circuit. These data would be compared to the pressure measured at a specific point of the circuit, the so called benchmark.

Another objective consists in the same device including computing means for pressure differences calculation, for storage of recorded data, and for remote data transmission.

A further objective is that the above said transducers are calibrated so to detect pressure variations in a range comparable to the full scale. The same full scale can be duly calibrated so to free the measurement from possible zero drift effects, due to temperature variations or to ageing of components.

Another advantage is the device's modularity: it is possible to add or remove some single measuring modules, depending on specific installation requirements, and, in case of failure, exclude one or more modules without jeopardising the overall system operation.

Another goal is the possibility of laying the device on the seabed, close to an off-shore platform or any other submerged structure, and covering it with a thick enough soil layer so to be protected against shocks or natural submarine phenomena.

A further advantage consists in the possibility of connecting the device to an external cable, laid along the above said undersea structure, to allow remote data transmission and reception of non stop power supply necessary for operations.

Therefore, the core of this invention is a specific device tailored to measure the development of soil and/or seabed surface profile, essentially consisting of a watertight/airtight casing that houses:
an hydraulic pressurized circuit, extending along a longitudinal direction, containing specific liquid;
a pneumatic circuit, extending along the same longitudinal direction and in connection with the above hydraulic circuit at one or more points. The pneumatic circuit, filled with air at constant pressure or inert gas, allows pressurisation of the above said hydraulic circuit;
a set of differential pressure transducers, placed at the above said one or more communication points, between the hydraulic and the pneumatic circuits;
an electronic control circuit which includes: data acquisition units (being data supplied by above pressure transducers and related to pressure measurements taken on above one or more benchmarks), computing means for pressure difference calculation in respect to a reference point, the so called benchmark; storage means for recorded data; and means for data transmission to a remote acquisition unit;
   so to allow computation of altitude difference between the above one or more points, in respect to the benchmark. Such an altitude difference, being proportional to the detected pressure difference, according to the communicating vessels principle, determines the altitude profile of the device along the entire measuring line.

Compared to known devices, the present invention offers further advantages such as: very high accuracy and resolution of the recorded data (range of vertical displacements detected up to 0.1 mm); measurement of altitude profile ranging from 2 meters up to many kilometres; sturdiness of components and casings; use of standard components, resulting in a cost effective, long-lasting and reliable device.

This invention is now being described for illustrative but not limitative purposes, with particular reference to figures of the enclosed drawings, where:

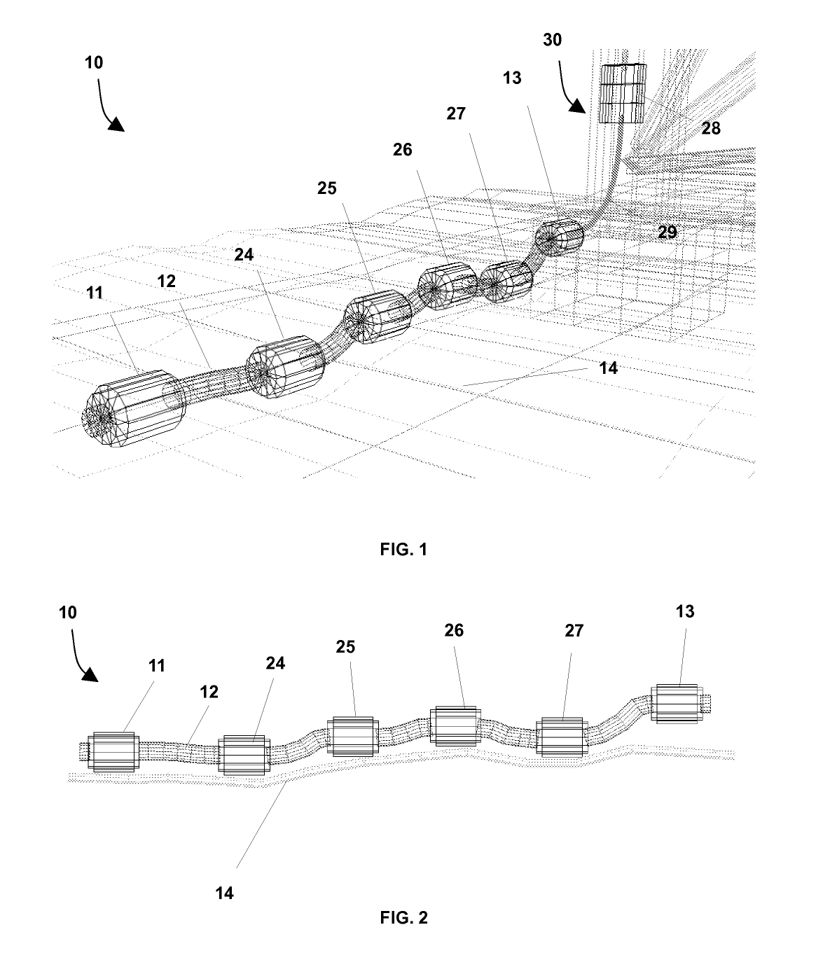

FIG. 1 is a perspective view of a device, measuring the seabed profile, installed close to an undersea structure (like an oil platform);

FIG. 2 is a lateral view of the same device in FIG. 1, where the installed position of its main components follows the seabed profile;

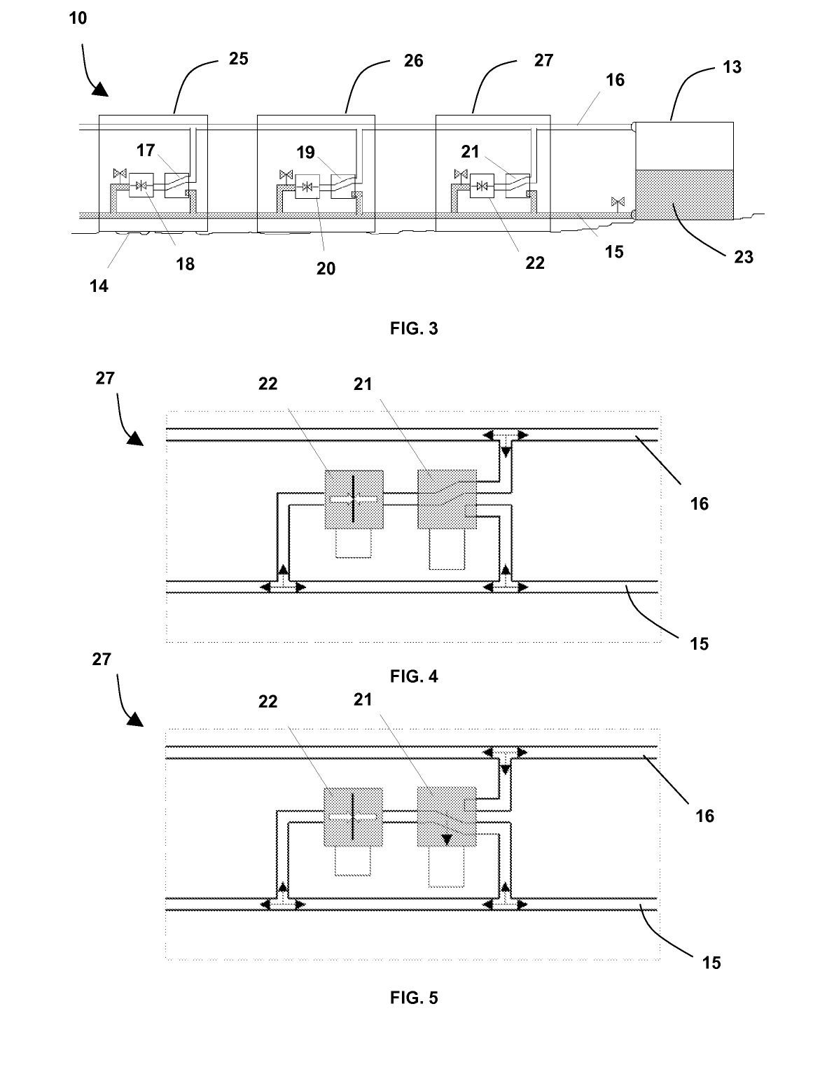

FIG. 3 is a schematic view of the hydraulic and pneumatic circuits, housed in the same device, where a set of differential pressure transducers are visible in their positions along the longitudinal direction;

FIG. 4 is a schematic view of a single module of the same device where the pressure transducer is placed at the junction between the hydraulic and the pneumatic circuit;

FIG. 5 is a schematic view of a single module of the same device where a switch valve makes the pressure transducer be activated by the same hydraulic pressure on both ends.

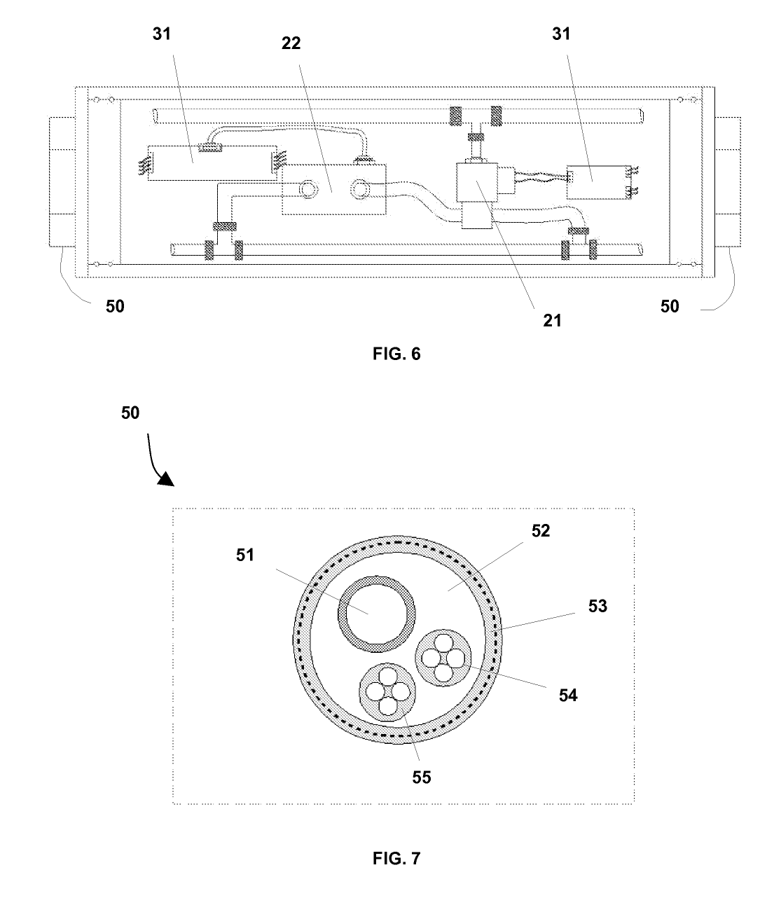

FIG. 6 is a lateral cross-section view of a single module of the same device just like the one of previous FIGS. 4 and 5, where the inner components and the electronic boards are better visualized;

FIG. 7 is a front cross-section view of a connecting pipe between the above modules, where the pipe sections connecting the hydraulic and pneumatic circuits plus a couple of electrical cables are shown;

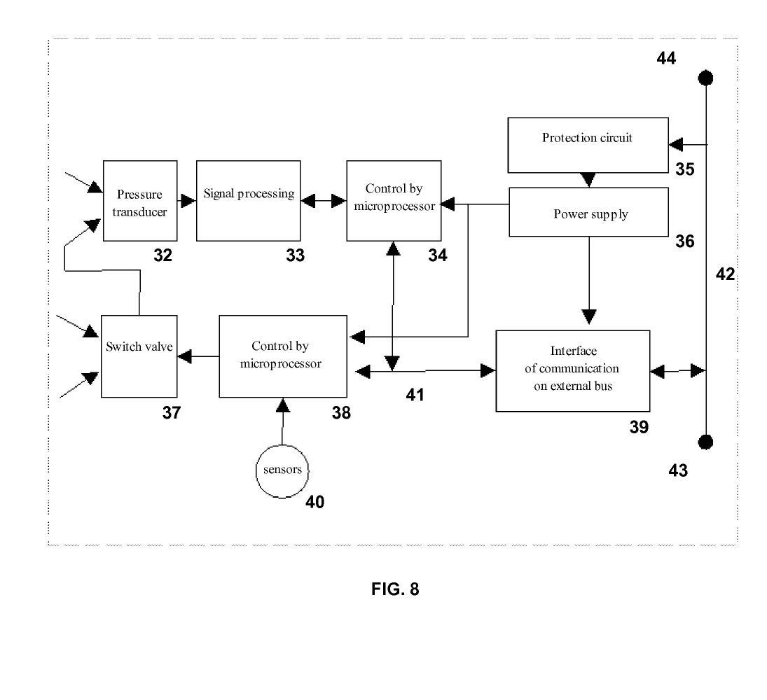

FIG. 8 is a block diagram of the electronic components in charge of the transmission and storage of recorded data and power supply.

It is here underlined that only few of the many conceivable embodiments of the present invention are described, which are just some specific non-limiting examples, having the possibility to describe many other embodiments based on the disclosed technical solutions of the present invention. The other different figures show the same elements using the same reference numbers.

FIGS. 1-2 show a device 10 for measurement of a seabed profile 14. It is formed by a number of units 11, 24, 25, 26, 27, and a reference unit 13, connected one another, in order to compose a structure extending along the longitudinal direction. Units 11, 24, 25, 26, 27, are the so called measuring modules, instead unit 13 is the so called benchmark.
Device 10 is placed on an underwater soil, along a path where measurement and/or monitoring of the area profiles is required for a very long lapse of time (i.e. years); this soil could be a seabed, a lake bed, a river bed; or other soils where activities of particular geological interest occur.
Measuring modules 11, 24, 25, 26, 27, are identical both for their electro-mechanic characteristics and for their measurement performances, which number depends on: the extension of the area to be monitored, the nature of the event, and on the resolution or detail level required.
The positions of modules 11, 24, 25, 26, 27, 13, are usually at a fixed distance one another, along the detection path, and do not required any special operation other than their assembly in the device before the installation process on site. Measurement modules 11, 24, 25, 26, 27, and benchmark n. 13, are respectively joined one another by means of the electro-hydraulic connection pipe 12, so to form a unique uninterrupted strip, having a length that may even reach some kilometres.
Connecting pipe 12 has a shape, mechanical characteristics and size, such to allow device 10 to be laid on seabed, or lake bed, or cross-laid on a river bed or any other water stream. The same connection pipe 12 is watertight and fully sealed, thus keeping all the inner components at a constant pressure regardless to the high pressure of the depth they are subjected. The seal of device 10 guarantees its operation at any depth, independently on the outer undersea pressure.
Furthermore, device 10 houses an electronic equipment, placed at each single module, that is connected by a transmission cable 29 to a remote control unit 28, which is in charge of data exchange and power supply to/from external units.
The remote control unit 28 can be fixed to underwater structure 30, for example, or to an oil platform, and be connected to the surface by a cable running up along the structure 30.
With reference to FIG. 3, all measuring modules (i.e. 25, 26, 27) are connected to a unique hydraulic circuit 15, and to a unique pneumatic circuit 16, both in common to all the modules. The measurement is taken by calculating the pressure difference between the hydraulic circuit 15 and the pneumatic circuit 16 along the detecting points respectively (i.e. 18, 20, 22).
This measuring method is based on the communicating vessels principle, where the difference of altitude profile between a specific point in the hydraulic circuit 15 and a reference vessel 23 full of liquid and connected to the same circuit 15 causes a difference of internal pressures transmitted by the same liquid that pulls/pushes at the same above points. At each detection point (i.e. 18, 20, 22) an hydraulic piezometric load is therefore applied to the respective differential pressure transducer which is directly proportional to the liquid volume contained in the section of the hydraulic pipe up to the reference vessel 23.
The detected pressure at each module Pᵢ is equal to the difference of pressures on the respective membranes of the differential transducer, that is:

Pᵢ=P_{R,i}−P_{A,i}=ρghᵢ+P_{A}−P_{A,i} (1)

where P_{R,i} is pressure in respect of reference 23, P_{A} is the atmospheric pressure, P_{A,i} is the atmospheric pressure detected locally, ρ is the fluid density, g is the gravity constant value and hᵢ is the height of column in respect of reference 23. Considering that the atmospheric pressure is kept constant all along device 10, by the common pneumatic circuit 16, it is obtained:

P_{A}=P_{A,i} (2)

and then:

Pᵢ=ρghᵢ (3)

According to the principle of the communicating vessels and to the Stevin's Law, said inner pressure, at the transducer, can be expressed by the formula:

Pᵢ=ρghᵢ=ρgh=P_{A} (4)

As a consequence, the difference of pressure Pᵢ detected by transducers is directly proportional to the difference of height hᵢ between respective measure units 25, 26, 27, and the reference unit 13. Thus, it is possible to define the height hᵢ difference as a function of pressure Pᵢ difference:

$${h}_{i} = h \frac{{P}_{A}}{{P}_{i}} \qquad ( 5 )$$

With reference to measurement module 27, FIGS. 4-5 show a further element particularly suitable for the correct calibration of the pressure transducer 22, and for the compensation of possible zero drift, due, for example, to temperature variation or ageing of materials.
This element consists of a switch valve 21, placed before the said pressure transducer 22, which switches on demand to the pneumatic circuit 16 (like in FIG. 4) or to the hydraulic circuit 15 (like in FIG. 5).
In its standard working conditions (FIG. 4), the pressure transducer 22 receives on a first membrane the pressure from the hydraulic circuit 15, and on the second membrane the pressure from the pneumatic circuit 16, so that it detects the difference of pressures at the same point.
Considering the error component affecting the value of pressure Pᵢ, and the value of pressure P_{A}, the result of measurement is:

U_{MIS}=(P_{R}+E_{P1})−(P_{A}+E_{P2})−U_{ZERO} (6)

where U_{MIS} is the output value from transducer 22, E_{P1} is the error component on the reference pressure P_{R}, E_{P2} is the error component on pressure P_{A}, and U_{ZERO} is the latest detected zero value. In the calibration position (FIG. 5), the pressure transducer 22 receives on a first membrane the pressure from the hydraulic circuit 15, and on the second membrane the pressure from the same hydraulic circuit 15, so that it detects the zero value, that is:

U_{ZERO}=(P_{R}+E_{P1})−(P_{R}+E_{P2})=E_{P1}−E_{P2} (7)

Once the parameter U_{ZERO} is evaluated, it can be replaced in the previous formula (6) related to the standard working conditions of the device, so that zero drift compensation can be obtained.
The calibration procedure is carried out through specific commands, sent from a remote site to the inner electronic circuits, otherwise it can be achieved in a completely stand-alone mode, provided by a control software for automatic and routine calibration of the device.
FIG. 6 shows the position of instrument 31 housed by each measuring module. The same instrument, or so called electronic circuit 31, sends electric signals to actuators so to allow switching of valve 21 towards the calibration position or towards the standard working position.
In the calibration position, instrument 31 detects and acquires the zero value from pressure transducer 22, and calibrates the inner compensation parameters. In the standard working position, the same instrument 31 acquires a pressure reading from transducer 22, calculates the pressure difference in respect of the benchmark point 13, and sends the data to a remote in/out control unit 28.
FIG. 8 shows a block diagram of the electronic components performing the communication process for data reading and control, and the power supply.
The electrical signals, coming from pressure transducer 32, are processed in the electronic circuit 33 that includes: a two-channel amplifier with strain gauge, a double DC current generator, a sensor for inner temperature, and a multi-channel high resolution A/D converter. Circuit 33 is controlled by module 34, that includes a microprocessor with a non-volatile memory storing the data from the calibration process, the sensitivity value and the zero value.
The calibration data are referred to the inner temperature and are processed by a specific algorithm that converts electrical signals in a high resolution pressure measurement, thus compensating the zero measurement in a range from 0 to 50° C. Furthermore, module 33 communicates directly with the inner bus 41 and through module 39, with the field bus 42, that is external and in common to all the measuring modules, through the electric communication lines (ports 43 and 44). Module 39 provides the impedance matching, insulation and electric protection of the communication active elements 34, 38 against possible damages caused by induced events on the external communication lines.
Module 38 provides the remote control to the electric valve, or switch valve 37, in order to activate the compensation function against possible zero drift, as previously described. The same module 38 includes a microprocessor that generates the control signals for the actuator of valve 37, according to an optimisation process for energy saving. This process consists in a maximum voltage supply to valve 37 at the very beginning of actuation to decreased voltage to a minimal operating level, during the reading of the zero value.
The measuring module also houses some sensors 40 in correspondence to the closing elements and the O-rings so to detect any possible humidity increase or even water inflowing device 10. Sensors 40 are kept under control by circuit 38 that, through module 39 and field bus 42, sends a warning signal to the external unit 28 in case of malfunctioning and/or system failures. The electronic components are further protected and isolated from the power supply lines through circuit 35. Power unit 36 provides the required power supply and adapt the input voltage to the values requested by the electronic circuits, in a range from 10V to 200V, depending on the distance and the number of measuring modules—25, 26, 27—working contemporarily.
With reference to the entire device 10, as already said, all the measuring modules 11, 24, 25, 26, 27 and benchmark 13 are interconnected through connection pipes which house the tubing sections of the hydraulic circuit 15 and of the pneumatic circuit 16, plus two connection electrical cables.
FIG. 7 shows a section of a connection pipe 50, having an external surface 53 made of an hydraulic rubber tube, stiffened by an embedded steel sheath to provide high robustness and long life.
The connection pipe 50 is waterproof and airtight and, during assembly, the inner part 52 is saturated with an inert gas at atmospheric pressure. Atmospheric pressure can be kept steady even in case of slight mechanical deformations that may occur during system installation at very high depth. An elastic membrane, close to the pneumatic circuit, at the side of benchmark 13, is able to compensate possible small variations of volume, and consequently variations of pressure, for the gas contained inside. The same connection pipe 50 contains the hydraulic sections 51 which connect the modules of device 10 plus a couple of independent tubes containing the electrical cables 54 and 55. Some electrical cables provide the power supply to the electronic gauges such as to the measuring circuits, differential transducers, communication interfaces, switch valves and control interfaces; whereas other cables convey the transmission of digital data from/to the external control unit 28.
In order to increase the reliability of device 10 against risks of failure in the single modules, above tubes 54 and 55 connect all the modules in even positions and in odd positions respectively. By so doing the same device 10 will not stop working even in case of failure of a single module that would cause the interruption of the electrical transmission chain, thus assuring at least the 50% of functionality.

This invention involves many different achievements depending on the technical and project parameters aiming at a specific final application. As a general reference, the number of measurement modules 25, 26, 27 may range from 2 to 250, and the overall length of device 10 may range from 2 metres to many kilometres. The arrangement of modules 25, 26 and 27 may follow a linear geometrical profile, as previously described, but may also have a spokes or a tree pattern.

Each of the same modules 25, 26, 27 may have a cylindrical shape, with 0 size ranging from 60 to 200 mm, and ranging from 150 to 800 mm as length. As for the materials, the measuring modules 25, 26, 27 are made of plastic such as Nylon77®, or metal such as stainless steel AISI 316L; instead each connecting pipe 50 is made of a specific material such as. Nylon®, Rilsan®, or polypropylene. The liquid in the hydraulic circuit 15 is a steady and anti-corrosive fluid, having a density of more than 0.5 kg/m³: for on-shore applications the liquid to be used may be a diluted ethylene glycol, or a very fluid silicone oil (1-2 Cst); instead, for off-shore applications the liquid to be used has to be a substance with a low environmental impact, such as Galden® or Fomlin®.

After description of above examples there is evidence to say that this invention achieves all its goals and, In particular, a special device specifically suitable to measure the development of land and seabed profile. This device, fully sealed from the outer environment, houses a pressurised hydraulic circuit with a range of differential pressure transducers. These differential pressure transducers supply the pressure data taken at different points of the same hydraulic circuit. These data are compared to the pressure value taken at a specific point of the circuit, the so called benchmark.

Furthermore, the same device includes means for calculation of pressure differences, for storage of recorded data, and for remote data transmission.

The same invention involves transducers to be calibrated to detect pressure variations in a range comparable to the full scale value. Such a full scale may be duly calibrated so to compensate a possible zero drift due to temperature variations or material ageing.

Last but not least the device has modular features thus allowing single parts to be added or replaced depending on the specific installation requirements or in case of failure, without jeopardising the overall system's operation.

In addition, this device can be laid on the seabed, close to an off-shore platform or any other undersea structure and covered by a sufficiently thick soil layer to be protected against any possible undersea activities or natural events.

Finally, the same device can be connected to an external cable, installed along the said undersea structures, so to provide remote data transmission and, at the same time, constant power supply for non-stop operation.

This invention is described for illustrative but not limitative purposes, following some preferred achievements; however it goes without saying that modifications and/or changes would be introduced without departing from the relevant scope, as defined in the enclosed claims.

1. A device having an airtight structure, for measuring the development of soil or seabed geometrical profile, comprising:
an hydraulic pressurized circuit, extending along a longitudinal direction, and containing a specific liquid;
a pneumatic circuit, extending along the same longitudinal direction, and communicating, at one or more points, with said hydraulic circuit, said pneumatic circuit filled with constantly pressurised air or inert gas, so to guarantee constant pressurisation of the hydraulic circuit;
a number of differential pressure transducers, placed at each of communication points, between the hydraulic and the pneumatic circuit; and
an electronic control circuit comprising,
a data acquisition unit configured to obtain data from the pressure transducer;
a computing unit configured to calculate a pressure difference in respect to a reference point (benchmark);
a storage unit configured to store recorded data; and
a remote data transmission unit configured to transfer the data to an external control unit,
wherein the device allows computation of the altitude profile difference at each of communication points, in respect to said benchmark, all along its longitudinal length.

2. The device according to claim 1, further comprising a measuring module which is full sealed from outer environment and made with sturdy and flexible material,
wherein:
the pressure transducer and the electronic control circuit are housed in said measuring module as well as sections of the hydraulic circuit and the pneumatic and an inner connection pipe;
the pressure transducer is either single or double differential pressure transducers;
the benchmark is made of a single reference module, containing a reference vessel, connected to the hydraulic circuit and the pneumatic circuit; and
a plurality of said measuring modules is connected in series so to form a chain, through the inner connection pipes according to specific installation requirements, size of the area to be monitored and accuracy detail of soil profile.

3. The device according claim 1, further comprising a calibration unit comprising a switch valve placed in each of measuring modules, before the pressure transducer, that toggles between a first position and a second position,
wherein in the first position, the pressure transducer receives a pressure from the hydraulic circuit on a first membrane and a pressure from the pneumatic circuit on a second membrane, so to detect the pressure difference at the same point and in the second position, the pressure transducer receives the pressure from the hydraulic circuit on the first membrane and the pressure from the same hydraulic circuit on the second membrane so to detect the zero value for calibration of inner compensation parameters.

4. The device according to claim 3,
wherein the electronic control circuit is further configured to:
control the switch valve;
provide automatic and routine calibration of the device as addition or alternative to the remote data transmission unit; and
to acquire the zero measurement from the pressure transducer and calibrate the internal compensation parameters,
wherein the pressure taken by the pressure transducer is compensated automatically, to prevent a zero drift, due to thermal variations or ageing of materials.

5. The device according to claim 1, wherein the electrical control circuit comprises:
a signal processing module which works as a strain gauge two-channel amplifier, a double DC current generator, an inner temperature thermometer, and a multi-channel high resolution A/D converter;
a first control module including a microprocessor with a non-volatile memory for storage of calibration data sensitivity and zero values, wherein calibration data refer to the inner temperature and provide a zero compensation in a range between 0° C. and 50° C.;
an inner bus, providing a direct communication of said final processing module, and an outer field bus, common to every measuring module, providing an external communication of said signal processing module;
an interface module, provides impedance matching, isolation and electric protection of the active elements of communication first control unit, a second control module against possible damage due to induced events on the external communication lines;
the second control module, provides remote control of the switch valve, to activate the compensation function for possible zero drift said second control module includes a microprocessor that generates the control signals for an actuator of switch valve, according to an optimization process of energy saving;
a number of sensors, placed near the module closing elements and O-rings, to detect any possible increase of humidity or water inflowing the device, said sensors are in communication with the external control unit, to send signal warning for possible malfunctioning or system failure;
a protection module to isolate the electronic circuit from the power supply lines;
a power supply unit to provide power supply and convert, if necessary, the output voltage; to reduce and/or stabilise it along with the requirements of electronic circuits at a voltage between 10V and 200V, depending on distance and specific number of measurement modules that work contemporarily.

6. An optimization process comprising:
providing a maximum voltage supply to the switch valve of claim 5 at the very beginning of its actuation, and decreasing the voltage to a minimum operation level, during the reading of the zero value.

7. The device according to claim 2, wherein:
said inner connection pipe is sealed and airtight and, during factory assembly, filled with inert gas at atmospheric pressure; and
said device also houses an elastic membrane, placed in the pneumatic circuit by the benchmark, the membrane will compensate possible small volume variations and, as a consequence, pressure variations of the gas inside,
so that the atmospheric pressure is kept inside the device at a constant level, even in case of small mechanical deformations, due to installation at significant depth on the seabed.

8. The device according to claim 2, wherein:
said inner connection pipe houses a pair of independent electrical cables for transmission of: a.) the power supply to the electronic equipment, b.) the digital data from/to the external control unit;
said pair of cables connect a plurality of the measuring modules alternately so that the device will operate non-stop even in case of failure in a single measuring module that would cause the interruption of the electric transmission chain, thus assuring at least 50% of functionality.

9. The device according to claim 2, wherein:
said measuring modules are in a number ranging from 2 to 250 corresponding to an overall length extending from 2 metres to at least 3 kilometres or more;
the configuration of modules may have a linear geometrical profile, or a spokes or a tree pattern; and
each of the modules has a cylindrical shape, with sizes from 60 to 200 mm as diameter, and from 150 to 800 mm as length.

10. The device according to claim 2, wherein:
the measuring module is made of a plastic material like Nylon77®, or a metallic material like stainless steel AISI 316L; and
each inner connecting pipes is made of a specific plastic material like Nylon®, Rilsan®, or polypropylene;

11. The device according to claim 1, wherein the liquid filling the hydraulic circuit, is a steady anti-corrosive liquid, having a density of more than 0.5 kg/m³, said liquid is diluted ethylene glycol, or a very fluid silicone oil (1-2 Cst) for on-shore applications and Galden® or Fomlin® for off-shore applications.
